(19) United States
(12) Patent Application Publication
(10) Pub. No.: US 2026/0278172 A1
(43) Pub. Date: Sep. 17, 2026

(54) SECURE PROVISIONING OF A PROGRAMMABLE DEVICE

(71) Applicant: SECURE THINGZ LIMITED, Cambridge, Cambridgeshire (GB)

(72) Inventor: Jon GORDON, Cambridge, Cambridgeshire (GB)

(21) Appl. No.: 19/129,218

(22) PCT Filed: Nov. 16, 2023
(86) PCT No.: PCT/EP2023/082144

§ 371 Date: May 12, 2025

(30) Foreign Application Priority Data
Nov. 24, 2022 (GB) 2217596.2

(51) Int. Cl. G06F 21/64; G06F 21/44; G06F 21/60; H04L 9/08

(52) U.S. Cl. CPC G06F 21/64; G06F 21/44; G06F 21/602; H04L 9/0877

(57) ABSTRACT

A device configured to: receive and decrypt an encrypted data package to obtain: a software image for programming onto a programmable device, a first location identifying a location of unprotected sensitive data in the software image, a second location and third location; extract the unprotected sensitive data using the first location; transform the unprotected sensitive data into protected sensitive data; generate a modified software image by inserting the protected sensitive data into the software image and associating the protected sensitive data with the second location; transmit the modified software image to a programming module, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

### TECHNICAL FIELD

The present application relates to a security data processing device used in the programming of programmable devices, and operation of the programmable devices once programmed using the security data processing device.

### BACKGROUND

A Hardware Security Module (HSM) is often used to deploy software code and/or cryptographic keys onto a programmable device securely (for use in a consumer device).

A Hardware Security Module is a device that can create and hold private keys and secret keys securely so that they may not be extracted. The HSM also provides the ability to perform some selected cryptographic operations with the keys.

Programmable devices (e.g. microprocessor and microcontroller devices) need software to run, and some or all this software, might contain sensitive data or other intellectual property (IP) that the owner does not want to be exposed.

Because the programmable device is sold to potential attackers it is problematic to prevent anyone from extracting the code and disassembling it to find the sensitive data or other IP. Another focus point is the initial provisioning of the programmable device in a factory that the Original Equipment Manufacturer (OEM) who developed the software does not usually own, so exposure to factory staff who might try to extract it, is also problematic.

### SUMMARY

The inventor has identified that a programmable device has the capability to lock down address ranges in non-volatile memory (e.g. flash) and volatile memory (e.g. RAM) to prevent normal debuggers (JTAG etc.) from being able to extract the contents. This lock-down is usually the last stage of the provisioning, so access to IP in the factory prior to lock-down is the highest risk. However, it is still possible for a purchaser of the programmable device to physically skim the top off chips and get access to the flash that was intended to be locked-down.

The inventor has identified that sensitive data or other IP should be protected (e.g. encrypted) at rest so that any copy that survives a power cycle is protected and therefore inaccessible from a potential attacker.

According to one aspect of the present disclosure there is provided a security data processing device comprising a processor, the processor configured to:
receive an encrypted data package from a third party device;
decrypt the encrypted data package to obtain:
   a software image for programming onto a programmable device,
   a first location identifying a location of unprotected sensitive data in the software image,
   a second location of non-volatile memory of the programmable device for storage of protected sensitive data, and
   a third location of volatile memory of the programmable device for storage of the unprotected sensitive data;
extract the unprotected sensitive data from the software image using the first location;
transform the unprotected sensitive data into protected sensitive data;
generate a modified software image by inserting the protected sensitive data into the software image and associating the protected sensitive data with the second location;
transmit the modified software image to the programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

If the power is removed from the programmable device, any data stored in the volatile memory of the programmable device will be lost so the sensitive data is protected ‘at rest’ (i.e. throughout the lifetime of the product in which the programmable device is incorporated into). The program is configured such that there is no instance of the unprotected sensitive data permanently held in the clear on the programmable device, only in protected (e.g. encrypted) form. Furthermore, the sensitive data is also never in the clear after it is protected by the security data processing device, so a factory that provisions the programmable devices will not be able to view the sensitive data in the clear.

The security data processing device may be configured to transform the unprotected sensitive data into the protected sensitive data by obfuscating the unprotected sensitive data.

The security data processing device may be configured to transform the unprotected sensitive data into the protected sensitive data by encrypting the unprotected sensitive data using an encryption key.

In some embodiments, the security data processing device is configured to generate the encryption key.

The security data processing device may be further configured to:
transmit a request to the programming module for a unique device credential of the programmable device;
receive the device credential from the programming machine; and
generate the encryption key using the unique device credential.

Thus the encryption key does not need to be provisioned (copied from the security data processing device to the programmable device possibly in the clear) at provisioning time. This is because the factory could extract the provisioning key along with the protected sensitive data (e.g. encrypted data) and transform the protected sensitive data into unprotected sensitive data (e.g. decrypt the encrypted data). Also without unique device credentials the factory would otherwise be able to make clones by copying non-volatile memory (e.g. flash) from one programmable device to a clone device.

The unique device credential includes one or any combination of:
a serial number of the programmable device;
wafer information associated with a wafer used to manufacture the programmable device; and
information stored in a Secure Enclave on the programmable device;
information derived from information stored in the Secure Enclave on the programmable device

In some embodiments, the encryption key is stored on the programmable device and the security data processing device is further configured to:
transmit a request to the programming module for the encryption key stored on the programmable device; and
receive the encryption key from the programming module.

The security data processing device may be further configured to:
transmit a request to the programming module for a key stored on the programmable device;
receive the key from the programming module; and
generate the encryption key using the key received from the programming module.

The security data processing device may be further configured to: transmit registration information to a remote device via a communications network, and receive the encryption key from the remote device following successful registration with the remote server based on the registration information.

The encryption key may be unique to the programmable device.

The software image may be for programming onto a plurality of programmable devices, and the encryption key may be used for programming all or a subset of the plurality of programmable devices.

The security data processing device may be further configured to;
receive an authentication request from the third party device; and
transmit an authentication response to the third party device, wherein the encrypted data package is received from the third party device in response to being successfully authenticated by the third party device.

Thus, the security data processing device may prove to the owner of the sensitive data (also referred to herein as a third party) that the security data processing device is an authentic security data processing device prior to receiving the encrypted data package.

The authentication response may comprise one of more digital certificates associated with the security data processing device.

This enables the third party device (associated with the owner of the sensitive data) to then validate that the digital certificate(s) are rooted in a trusted anchor that it knows from the manufacturer of the security data processing device.

The first location may be the same as the second location. Alternatively, the second location partially overlaps the first location. Alternatively, the second location may be distinct from (i.e. different to) the first location.

The processor may be configured to decrypt the encrypted data package using a decryption key which is unique to the security data processing device.

This ensures that only this particular security data processing device is able to access the contents of the encrypted data package.

The security data processing device may be a Hardware Security Module (HSM).

According to another aspect of the present disclosure there is provided a non-transitory computer-readable medium, the non-transitory computer-readable medium storing instructions that, when executed by a processor, cause the processor to:
receive an encrypted data package from a third party device;
decrypt the encrypted data package to obtain:
   a software image for programming onto a programmable device,
   a first location identifying a location of unprotected sensitive data in the software image,
   a second location of non-volatile memory of the programmable device for storage of protected sensitive data, and
   a third location of volatile memory of the programmable device for storage of the unprotected sensitive data;
extract the unprotected sensitive data from the software image using the first location;
transform the unprotected sensitive data into protected sensitive data;
generate a modified software image by inserting the protected sensitive data into the software image and associating the protected sensitive data with the second location;
transmit the modified software image to the programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

The instructions, when executed by the processor, may cause the processor to perform any of the methods described herein in relation to the security data processing device.

These instructions may be provided on a carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a method comprising:
receiving an encrypted data package from a third party device;
decrypting the encrypted data package to obtain:
   a software image for programming onto a programmable device,
   a first location identifying a location of unprotected sensitive data in the software image,
   a second location of non-volatile memory of the programmable device for storage of protected sensitive data, and
   a third location of volatile memory of the programmable device for storage of the unprotected sensitive data;
extracting the unprotected sensitive data from the software image using the first location;
transforming the unprotected sensitive data into protected sensitive data;
generating a modified software image by inserting the protected sensitive data into the software image and associating the protected sensitive data with the second location;
transmitting the modified software image to a programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

According to another aspect of the present disclosure there is provided a programmable device comprising:
a processor;
a non-volatile memory; and
a volatile memory; wherein the processor is configured to perform steps of:
retrieve protected sensitive data that is stored in non-volatile memory;
determine if the protected sensitive data is valid;
if the protected sensitive data is valid; the processor is configured to:
transform the protected sensitive data into unprotected sensitive data;
store the unprotected sensitive data in the volatile memory whilst retaining the protected sensitive data in non-volatile memory.

The programmable device may be configured to transform the protected sensitive data into the unprotected sensitive data by deobfuscating the protected sensitive data.

The programmable device may be configured to transform the protected sensitive data into the unprotected sensitive data by decrypting the protected sensitive data using a decryption key.

The processor may be further configured to generate the decryption key using a unique device credential of the programmable device.

If unique device credentials for a programmable device are used to generate the decryption key then this prevents the transfer of the protected sensitive data into a cloned device as the cloned device will have different credentials and not be able to access the protected sensitive data (e.g. by decrypting encrypted sensitive data)

Part of the production of a consumer device (such as a smartphone, tablet or other internet of things (IoT) device) may include the OEM sub-contracting a controller of a factory (e.g. a contract manufacturer) to program digital information onto an agreed number of programmable devices, where the number of programmable devices to be programmed has been agreed between the OEM and the factory controller. Extra devices produced by programming more than the agreed number are known as cloned devices. Cloned devices may be seen as counterfeit devices or unofficial devices but physically they may be very similar or identical to the official programmable devices.

It is advantageous for the OEM to prevent cloned devices produced by a factory controller, intermediary or any other interloper, ideally there will be no cloned devices produced. This is because cloned devices can be adverse to the OEM for numerous reasons. For example, cloned devices may demand support from the OEM or may use network resources. This can have the effect of lowering the capability of genuine (i.e. non-cloned) devices because servers designated to communicate with the genuine consumer devices may be overburdened due to requests from cloned (i.e. non-genuine) devices. Additionally, faultily produced cloned devices may damage a reputation of the OEM. As a cloned device may be indistinguishable from a genuine device, the OEM may lose resources by repairing, updating or servicing cloned devices. This can therefore lower the efficiency of producing and maintaining products.

The programmable device may be further configured to transmit registration information to a remote device via a communications network, and receive the decryption key from the remote device following successful registration with the remote server based on the registration information.

The processor may be configured to perform the steps in response to power being delivered to the programmable device.

If the protected sensitive data is invalid, the processor may be configured to:
prevent start-up of the programmable device; or
allow start-up of the programmable device and prevent access to the protected sensitive data.

The processor may be configured to perform the steps in response to receiving a request for the protected sensitive data.

The processor may be configured to determine if the protected sensitive data is valid based on determining that the protected sensitive data is complete.

The processor may be configured to determine if the protected sensitive data is valid based on determining that the protected sensitive data has been generated specifically for the programmable device.

The processor may be configured to determine if the protected sensitive data is valid based on successfully verifying the integrity of the protected sensitive data.

The non-volatile memory may be flash memory. The volatile memory may be Random Access Memory.

According to another aspect of the present disclosure there is provided a non-transitory computer-readable medium, the non-transitory computer-readable medium storing instructions that, when executed by a processor of a programmable device, cause the processor to:
retrieve protected sensitive data that is stored in non-volatile memory of the programmable device;
determine if the protected sensitive data is valid;
if the protected sensitive data is valid; to:
transform the protected sensitive data into unprotected sensitive data;
store the unprotected sensitive data in volatile memory of the programmable device whilst retaining the protected sensitive data in the non-volatile memory.

The instructions, when executed by the processor, may cause the processor to perform any of the methods described herein in relation to the security data processing device. These instructions may be provided on a carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a method comprising:
retrieving protected sensitive data that is stored in non-volatile memory of the programmable device;
determining if the protected sensitive data is valid;
if the protected sensitive data is valid, the method further comprising:
transforming the protected sensitive data into unprotected sensitive data; and
storing the unprotected sensitive data in volatile memory of the programmable device whilst retaining the protected sensitive data in the non-volatile memory.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 shows a schematic block diagram of a programming system.

FIG. 2 shows a schematic block diagram of a security data processing device;

FIG. 3 shows a schematic block diagram of a programmable device;

FIG. 4 illustrates portions of memory allocated for storage of a software image;.

FIG. 5 is a flowchart illustrating a method performed by the security data processing device;

FIG. 6a illustrated portions of memory allocated for storage of a modified software image according to a first example;

FIG. 6b illustrated portions of memory allocated for storage of a modified software image according to a second example;

FIG. 6c illustrated portions of memory allocated for storage of a modified software image according to a third example;

FIG. 7 is a flowchart illustrating a method performed by the programmable device; and

FIG. 8 illustrates the programmable device transforming protected sensitive data into unprotected sensitive data and storing the unprotected sensitive data in volatile memory whilst retaining protected sensitive data in non-volatile memory.

### DETAILED DESCRIPTION

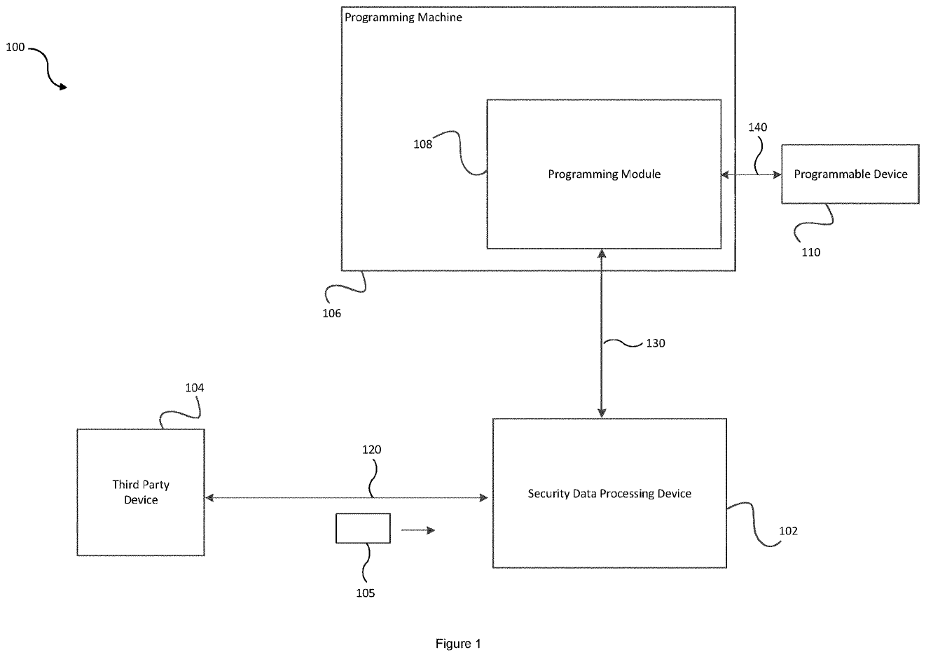

FIG. 1 shows a block diagram of a programming system 100.

The programming system 100 comprises a security data processing device 102, a third party device 104, a programming machine 106 (comprising a programming module 108), and a programmable device 110.

As shown in FIG. 1, the third party device 104 and the security data processing device 102 are able to communicate with each other via a communication channel 120. The communication channel 120 may be a wired and/or wireless communication link. As will be explained in more detail below, the security data processing device 102 is arranged to receive an encrypted data package 105 from the third party device 104 that is transmitted from the third party device 104 over the communication channel 120. The security data processing device 102 may transmit production records back to the third party device 104 using the communication channel 120. The production records comprise information about the provisioning of the programmable devices 110.

The third party device 104 may be a device such as a general-purpose computing device under the control of a third party such as an OEM, or a commissioner of the programmable device and/or a product which will comprise the programmable device 110.

The security data processing device 102 may have physical restrictions that prevent unauthorised parties from tampering with the security data processing device 102 or from obtaining information from it. The security data processing device 102 referred to herein may be a group of security data processing devices, either in the same location or spread across multiple locations. The security data processing device referred to herein may be a Hardware Security Module (HSM) or any other processing device. For example, the security data processing device 102 could be a server with the functionality of an HSM.

The security data processing device 102 and the programming module 108 are able to communicate with each other via a communication channel 130. The communication channel 130 may be a wired and/or wireless communication link.

The programming machine 106 is configured to program programmable devices such as programmable device 110 using the programming module 108. In other words, the programming machine inputs, or ‘programs’, software and other digital information onto a memory of the programmable device 110. The programming module 108 may transmit a request for programming information, via the communication channel 130, to the security data processing device 102. The security data processing device 102 is configured to transmit a software image to the programming module 108 for programming onto the programmable device 110. The functionality of the programming module 108 described herein may be implemented by a processor on the programming machine 106. The functionality of the programming module 108 may be implemented in code (software) stored on a memory of the programming machine 106 comprising one or more storage media, and arranged for execution on the processor of the programming machine 106 comprising one or more processing units. Alternatively, it is not excluded that some or all of the functionality of the programming module 108 is implemented in dedicated hardware circuitry (e.g. ASIC(s), simple circuits, gates, logic, and/or configurable hardware circuitry like an FPGA).

The security data processing device 102 may be a separate device to the programming machine 106. Alternatively, the security data processing device 102 may be part of and/or encased in the programming machine 106.

The programming machine 106 and the programmable device 110 are able to communicate with each other via a communication channel 140. Typically, the communication channel 140 will be a wired connection when the programmable device 110 is received into the programming machine 106.

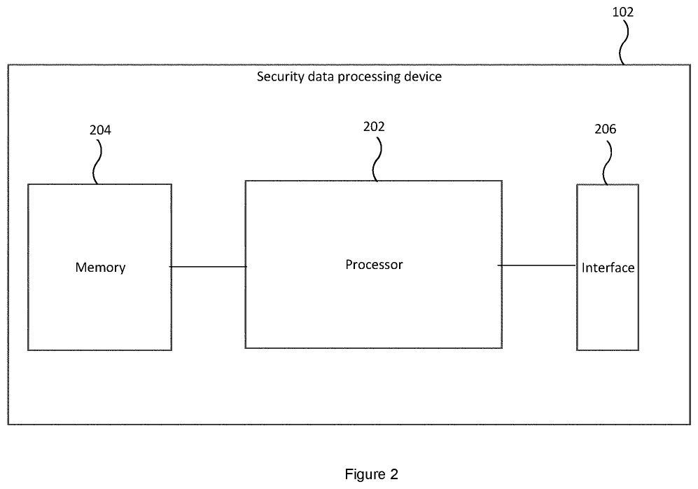

FIG. 2 shows a schematic block diagram of the security data processing device 102.

The security data processing device 102 comprises a processor 202, a memory 204 and an interface 206 to communicate with the third party device 104 and the programming module 108. The interface 206 may comprise a wired and/or wireless communications interface. The functionality of the processor 202 described herein may be implemented in code (software) stored on a memory (e.g. memory 204) comprising one or more storage media, and arranged for execution on a processor comprising one or more processing units. The storage media may be integrated into and/or separate from the processor 202. The code is configured so as when fetched from the memory and executed on the processor to perform operations in line with embodiments discussed herein. Alternatively, it is not excluded that some or all of the functionality of the processor 202 is implemented in dedicated hardware circuitry (e.g. ASIC(s), simple circuits, gates, logic, and/or configurable hardware circuitry like an FPGA).

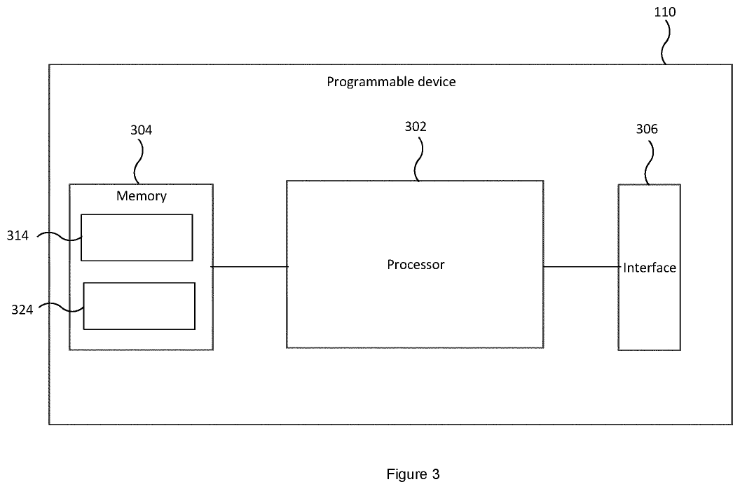

FIG. 3 shows a schematic block diagram of the programmable device 110. The programmable device may be for example a silicon chip, microprocessor or microcontroller.

The programmable device 110 comprises a processor 302, a memory 304 and an interface 306 to communicate with the programming module 108. The interface 306 enables the programmable device 110 to be provisioned with a software image that is transmitted from the programming module 108. Whilst a single programmable device 110 is shown in FIG. 1 for simplicity, it will be appreciated that the programming module 108 may be used to provision the same software image onto a plurality of programmable devices.

The functionality of the processor 302 described herein may be implemented in code (software) stored on a memory (e.g. memory 304) comprising one or more storage media, and arranged for execution on a processor comprising one or more processing units. The storage media may be integrated into and/or separate from the processor 302. The code is configured so as when fetched from the memory and executed on the processor to perform operations in line with embodiments discussed herein. Alternatively, it is not excluded that some or all of the functionality of the processor 302 is implemented in dedicated hardware circuitry (e.g. ASIC(s), simple circuits, gates, logic, and/or configurable hardware circuitry like an FPGA).

The memory 304 of the programmable device 110 comprises a volatile memory 314 e.g. Random Access Memory (RAM) and a non-volatile memory 324 (e.g. flash memory).

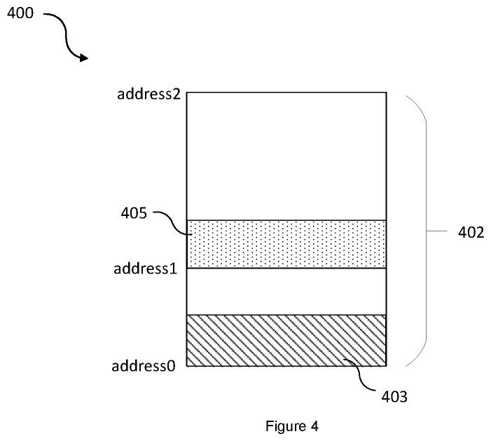

FIG. 4 illustrates portions of memory allocated for storage of a software image 400. The software image 400 is developed by a third party such as OEM to be provisioned by the programming module 108 onto a programmable device. The software image 400 comprises one or more computer programs for execution on the programmable device 110 and data for storage on the programmable device 110.

The software image 400 comprises information indicating where the computer program(s) and data forming the software image are to be stored on the programmable device 110. For example, the software image 400 comprises information indicating that contents 402 of the software image are to be stored in non-volatile memory of the programmable device 110 (e.g. non-volatile memory 324).

In particular, the software image 400 comprise a program 403 and includes information indicating that the program 403 is to be stored at a certain location (e.g. address0) in non-volatile memory of the programmable device 110. It will be appreciated that the software image 400 may specify that the program 403 is stored at a location which spans one or more addresses of the non-volatile memory of the programmable device 110.

The data for storage on the programmable device included in the software image 400 also comprises unprotected sensitive data 405 and information indicating that the unprotected sensitive data 405 is to be stored at a certain location (e.g. address1), otherwise referred herein as a “first location”, in non-volatile memory of the programmable device 110 (e.g. non-volatile memory 324). It will be appreciated that the software image may specify that the unprotected sensitive data 405 is stored at a location which spans one or more addresses of the non-volatile memory of the programmable device 110.

As will be explained in more detail below, the software image 400 is transmitted from the third party device 104 to the security data processing device 102 as part of the encrypted data package 105.

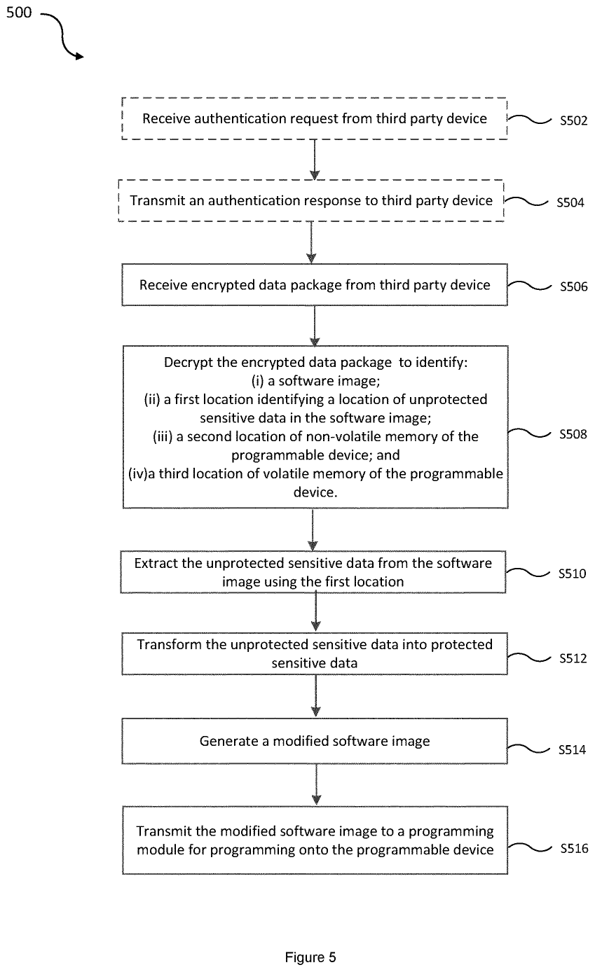

FIG. 5 is a flowchart illustrating a method 500 performed by the security data processing device 102. For example, the method 500 may be performed by the processor 202.

Prior to sending the encrypted data package 105 to the security data processing device 102, the third party (owner of the unprotected sensitive data 405) may validate the authenticity of the security data processing device 102. Thus at optional step S502, the processor 202 receives an authentication request transmitted from the third party device 104. The authentication request is transmitted from the third party device 104 over the communication link 120. The authentication request is received by the processor 202 via the interface 206.

At optional step S504, the processor 202 transmits an authentication response to the third party device via the interface 206. The authentication response is transmitted from the security data processing device 102 to the third party device 104 over the communication link 120. The authentication response may comprise one of more digital certificates associated with the security data processing device 102.

In response to receiving the authentication response from the security data processing device 102, the third party device 104 determines whether the security data processing device 102 is an authentic security data processing device. In implementations whereby the authentication response comprises one of more digital certificates associated with the security data processing device 102, the third party device 104 verifies the authenticity based on the digital certificate(s). In particular, the third party device 104 may verify the authenticity of the security data processing device 102 by validating that the certificate(s) are rooted in a trusted anchor that it knows from the manufacturer of the security data processing device 102.

In embodiments whereby optional steps S502 and S504 are performed, the third party device 104 transmits the encrypted data package 105 to the security data processing device 102 in response to determining that the security data processing device 102 is authentic.

At step S506, the processor 202 receives the encrypted data package 105 that is transmitted from the third party device 104

The encrypted data package 105 comprises the software image 400, which comprises the unprotected sensitive data 405.

The encrypted data package 105 additionally comprises a first location identifying a location of unprotected sensitive data 405 in the software image 400. The first location may comprise one or more addresses of non-volatile memory which should be used to store the unprotected sensitive data 405 on the programmable device 110.

The encrypted data package 105 additionally comprises a second location of non-volatile memory of the programmable device for storage of protected sensitive data. As will be explained below, the protected sensitive data is not included in the encrypted data package 105, but is instead generated by the security data processing device 102 using the unprotected sensitive data 405. The second location may comprise one or more addresses of non-volatile memory which should be used to store the protected sensitive data on the programmable device 110.

The encrypted data package 105 additionally comprises a third location of volatile memory of the programmable device for storage of unprotected sensitive data 405. The third location may comprise one or more addresses of volatile memory which should be used to store the unprotected sensitive data 405 on the programmable device 110.

At step S508 the processor 202 decrypts the encrypted data package 105 to identify the software image 400 (and the unprotected sensitive data 405), and the first, second, and third locations.

The third party device 104 may encrypt a data package (comprising the software image 400 and the first, second, and third locations) to generate the encrypted data package 105 such that it is targeted for delivery to a specific security data processing device i.e. security data processing device 102. For example, the third party device 104 may use a public key associated with the security data processing device 102 to encrypt the data package to generate the encrypted data package 105. In this example, the processor 202 uses a private key associated with the security data processing device 102 to decrypt the encrypted data package 105. The public key and private key form a key pair associated with the security data processing device 102. The security data processing device 102 may store the private key in memory 204.

It will be apparent to persons skilled in the art that various mechanisms may be employed by the security data processing device 102 to share its public key to the third party device 104. For example, the third party device 104 may obtain the public key associated with the security data processing device 102 from a digital certificate (comprising the public key) that is associated with the security data processing device 102. Such a certificate may be included in the authentication response transmitted to the third party device 104 at step S504. It will be appreciated that this is merely an example of how the third party device 104 may obtain the public key associated with the security data processing device 102.

The security data processing device 102 may transmit the public key associated with the security data processing device 102 to the third party device 104, whereby the public key is not included in a digital certificate.

Alternatively the manufacturer of the security data processing device 102 may communicate the public key to the third party associated with the third party device 104, for example via email or publicised on a website.

Once in possession of the software image 400 and the first, second, and third locations, at step S510 the processor 202 extracts the unprotected sensitive data 405 from the software image 400 using the first location. As noted above, the software image 400 comprises information indicating where the computer program(s) and data forming the software image 400 are to be stored on the programmable device 110, and thus the processor 202 can identify the unprotected sensitive data 405 from the software image 400 based on its storage location included in the software image 400 matching the first location.

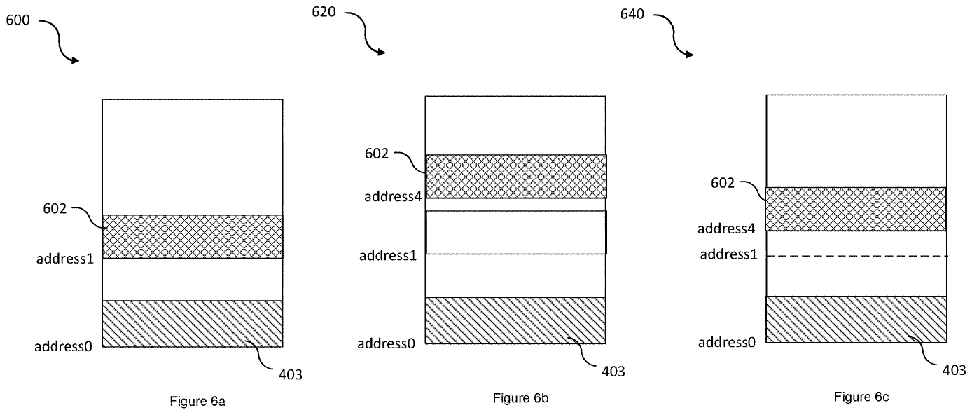

At step S512, the processor 202 transforms the unprotected sensitive data 405 into protected sensitive data 602 (illustrated in FIGS. 6a-6c).

Various techniques may be employed by the processor 202 to transform the unprotected sensitive data 405 into protected sensitive data 602.

In one example, at step S512 the processor 202 may encrypt the unprotected sensitive data 405 using an encryption key to generate the protected sensitive data 602. In this example, the protected sensitive data 602 is encrypted sensitive data.

As noted above, the programming module 108 may be used to provision the same software image onto a plurality of programmable devices. The processor 202 may be configured to encrypt the unprotected sensitive data 405 with different encryption keys for each programmable device. Using different keys for the encryption of the unprotected sensitive data 405 for each programmable device will discourage the factory from attempting to interfere at all in the provisioning process.

Alternatively, the processor 202 may be configured to encrypt the unprotected sensitive data 405 using one encryption key for all or a subset of the plurality of programmable devices. That is, the same encryption key may be used to encrypt the unprotected sensitive data 405 for multiple programmable devices.

The processor 202 may obtain the encryption key by one of various methods.

In embodiments whereby the encryption key used by the processor 202 to encrypt the unprotected sensitive data 405 is unique to a particular programmable device 110, the processor 202 may generate the encryption key using a unique device credential associated with the programmable device 110.

In order to generate the encryption key, the processor 202 may transmit a request, via the communication link 130, to the programming module 108 for a unique device credential of the programmable device 110. The programming module 108 then transmits a request, via the communication link 140, to the programmable device 110 for the unique device credential. Once the programming module 108 receives the unique device credential from the programmable device 110, the programming module 108 transmits, via the communication link 130, the unique device credential to the security data processing device 102. Thus, the processor 202 receives the unique device credential from the programming machine 108. The processor 202 may then generate the encryption key using the unique device credential.

The unique device credential may comprise information that is fused/burned into the programmable device 110 (such that it is immutable) e.g. in a fused register, by a manufacturer during fabrication of the programmable device 110. For example the unique device credential may comprise a serial number of the programmable device. In another example, the unique device credential may comprise wafer information associated with a semiconductor wafer used to manufacture the programmable device. The wafer information may comprise x/y co-ordinates of the wafer from which the particular programmable device was born. The wafer information may additionally comprise a unique identifier of the wafer from which the particular programmable device was born. The manufacturer of the programmable device may use One Time Programmable (OTP) memory or similar to set a unique identity for each programmable device that cannot be modified later at provisioning time. For some programmable devices this may be more than just an identity—it could be a complete secret key.

In other examples, the programmable devices may have a Physically Unclonable Function (PUF) which is a hardware construct that results in a unique value for each device, which can be used as the basis for deriving unique secret or private keys. In these examples, the unique device credential may correspond to the unique value or any key derived using the unique value.

The processor 302 is able to access the unique device credential and deliver it to the security data processing device 102 via the programming machine 106. The entire unique device credential is not simply stored in non-volatile memory (e.g. flash) such that it cannot be copied directly to clone devices.

In other examples, unique device credential may comprise immutable information that is stored in a Secure Enclave on the programmable device 110, or immutable information that is derived from information stored in a Secure Enclave on the programmable device 110.

In embodiments whereby the encryption key used by the processor 202 to encrypt the unprotected sensitive data 405 is unique to a particular programmable device 110, the encryption key may be stored on the programmable device 110, and the processor 202 may retrieve this encryption key from the programmable device 110.

In order to retrieve the encryption key that is stored on the programmable device 110, the processor 202 transmits a request, via the communication link 130, to the programming module 108 for the encryption key stored on the programmable device 110. The programming module 108 then transmits a request, via the communication link 140, to the programmable device 110 for the encryption key.

Once the programming module 108 receives the encryption key from the programmable device 110, the programming module 108 transmits, via the communication link 130, the encryption key to the security data processing device 102. Thus, the processor 202 receives the encryption key from the programming machine 108.

In embodiments whereby the encryption key used by the processor 202 to encrypt the unprotected sensitive data 405 is unique to a particular programmable device 110, the processor 202 may retrieve a key (e.g. a public key associated with the programmable device 110) that is stored on the programmable device 110 in order to generate the encryption key.

In order to retrieve the key that is stored on the programmable device 110, the processor 202 transmits a request, via the communication link 130, to the programming module 108 for the key stored on the programmable device 110. The programming module 108 then transmits a request, via the communication link 140, to the programmable device 110 for the key.

Once the programming module 108 receives the key from the programmable device 110, the programming module 108 transmits, via the communication link 130, the key to the security data processing device 102. Thus, the processor 202 receives the key from the programming machine 108. The processor 202 can then use the retrieved key to derive the encryption key. In these implementations, the encryption key itself is not stored on the programmable device 110.

In embodiments whereby the processor 202 is configured to encrypt the unprotected sensitive data 405 using one encryption key for all or a subset of the plurality of programmable devices, the processor 202 may obtain the encryption key in various ways.

In one example the security data processing device 102 may receive the encryption key from a remote device. For example, the third party device 104 may include the encryption key in the encrypted data package 105 that is transmitted to the security data processing device 102 via the communication link 120. In another example, the security data processing device 102 may receive the encryption key from a remote server. In this example, the security data processing device 102 may transmit registration information to the remote server via a communications network (e.g. the internet), and receive the encryption key from the remote server following successful registration with the remote server based on the registration information. In this example, a secure connection to the security data processing device 102 is first set up in operation then the security data processing device 102 is given information through that secure channel. This information might be a form of activation code to activate an encryption key already stored by the security data processing device 102, or the encryption key directly.

The security data processing device 102 may be provided with a master encryption key that is used to derive unique individual device keys using an algorithm using the unique device credential specific to each programmable device. In this case a registration server could hold the same master encryption key and use the device credentials delivered for registration to derive the right encryption key per device.

In another example, the security data processing device 102 may generate the encryption key itself.

As explained above, various techniques may be employed by the processor 202 to transform the unprotected sensitive data 405 into protected sensitive data 602 at step S512.

In another example, at step S512 the processor 202 may obfuscate the unprotected sensitive data 405 to generate the protected sensitive data 602. In this example, the protected sensitive data 602 is obfuscated sensitive data.

At step S514, the processor 202 generates a modified software image by inserting the protected sensitive data 602 into the software image 400 and associating the protected sensitive data 602 with the second location provided in the encrypted data package 105.

In the same way as the software image 400, the modified software image comprises information indicating where the computer program(s) and data forming the modified software image are to be stored on the programmable device 110. For example, the modified software image comprises information indicating that contents 402 of the software image are to be stored in non-volatile memory of the programmable device 110 (e.g. non-volatile memory 324).

As a result of step S514, the modified software image 400 generated by the processor 202 comprises the protected sensitive data 602 (generated by the processor 202) and information indicating that the protected sensitive data 602 is to be stored at the second location in non-volatile memory of the programmable device 110 (e.g. non-volatile memory 324). It will be appreciated that the modified software image may specify that the protected sensitive data 602 is stored at a location which spans one or more addresses of the non-volatile memory 324 of the programmable device 110.

In the same way as the software image 400, the modified software image comprises the program 403 and includes information indicating that the program 403 is to be stored at a certain location (e.g. address0) in non-volatile memory of the programmable device 110. It will be appreciated that the modified software image may specify that the program 403 is stored at a location which spans one or more addresses of the non-volatile memory of the programmable device 110.

As explained in more detail below with reference to FIGS. 6a-6c, the modified software image 600 is generated by the processor 202 by replacing the unprotected sensitive data 405 with the protected sensitive data 602. That is, the modified software image 600 does not comprise the unprotected sensitive data 405.

FIG. 6a illustrates portions of memory allocated for storage of a modified software image 600 according to a first example.

In the first example shown in FIG. 6a, the modified software image 600 comprises the protected sensitive data 602 and information indicating that the protected sensitive data 602 is to be stored at the same location in non-volatile memory which the software image 400 indicated was for storage of the unprotected sensitive data 405. That is, in this example the second location provided in the encrypted data package 105 is the same as the first location provided in the encrypted data package 105.

In a second example shown in FIG. 6b, the modified software image 620 comprises the protected sensitive data 602 and information indicating that the protected sensitive data 602 is to be stored at a second location (e.g. address4) in non-volatile memory which is different to the first location specified by the software image 400 for storage of the unprotected sensitive data 405. That is, in this example the second location provided in the encrypted data package 105 is different to (and non-overlapping with) the first location provided in the encrypted data package 105.

In a third example shown in FIG. 6b, the modified software image 640 comprises the protected sensitive data 602 and information indicating that the protected sensitive data 602 is to be stored at a second location (e.g. address4) in non-volatile memory which partially (and not completely) overlaps with the first location specified by the software image 400 for storage of the unprotected sensitive data 405. That is, in this example the second location provided in the encrypted data package 105 is different to, but partially overlaps with, the first location provided in the encrypted data package 105.

In all embodiments, the modified software image is generated such that no instance of the unprotected sensitive data will be permanently held in the clear on the programmable device 110, only in protected form (e.g. encrypted or obfuscated form).

It is clearer if the address space used for the protected sensitive data 602 does not overlap with the address space used for the unprotected sensitive data 405 (such as in the second example shown in FIG. 6b) as encrypt/decrypt from one block to another is usually more efficient, but space constraints might make it beneficial to do an overlap (such as in the examples shown in FIGS. 6a and 6c).

At step S514, the processor 202 transmits the modified software image, via the communication link 130, to the programming module 108 for programming onto the programmable device 110.

During provisioning of the programmable device 110, the programming module 108 will transmit the modified software image, via the communication link 140, to the programmable device 110. As the modified software image comprises the sensitive data in protected form, a malicious party will not be able to access the sensitive data via sniffing the communication link 140.

As noted above, the modified software image comprises the program 403. The program 403 is configured, once executed by the processor on the programmable device 110, to transform the protected sensitive data 602 into the unprotected sensitive data 405; and store the unprotected sensitive data 405 at the third location in volatile memory 314 of the programmable device 110 whilst retaining the protected sensitive data 602 at the second location in non-volatile memory 324 of the programmable device 110.

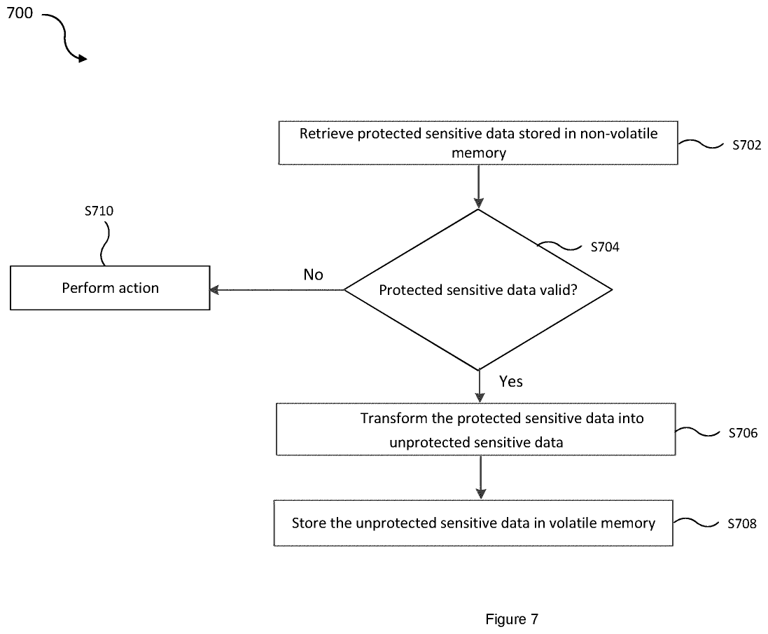

Operation of the programmable device 110 will be described now in more detail with reference to FIG. 7.

FIG. 7 is a flowchart illustrating a method 700 performed by the programmable device 110. For example, the method 700 may be performed by the processor 302 of the programmable device 110 in response to execution of the program 403 after the modified software image has been stored in non-volatile memory 324.

At step S702, the processor 302 is configured to retrieve the protected sensitive data 602 that is stored in non-volatile memory 324 (at the second location).

At step S704, the processor 302 is configured to determine whether the protected sensitive data 602 is valid.

There are various mechanisms which may be employed by the processor 302 to determine whether the protected sensitive data is valid.

For example, the processor 302 may determine that the protected sensitive data is valid based on determining that the protected sensitive data is complete. The processor 302 may determine that the protected sensitive data is complete based on checking for the presence of start and end markers. To detect the end of the protected sensitive data a length indicator could be used. To ensure an attacker has not changed the length the clear text length can be included in the authentication tag, such as in AES-128-GCM (Galois Counter Mode) where a block of readable data is included in the authentication tag.

Additionally or alternatively, the processor 302 may determine that the protected sensitive data is valid based on determining that the protected sensitive data has been generated specifically for the programmable device 110. For example, a header of the protected sensitive data protected by an authentication code could be validated by the processor 302 to determine that the protected sensitive data has been generated specifically for the programmable device 110

Additionally or alternatively, the processor 302 may determine that the protected sensitive data is valid based on successfully verifying the integrity of the protected sensitive data. Various mechanisms can be used to check the integrity of the protected sensitive data. Simple methods include the security data processing device 102 appending a checksum or cyclic redundancy check (CRC) to the protected sensitive data which can be verified by the processor 302. In another method, the processor 302 may determine that the protected sensitive data is valid based on verifying a message authentication code.

If the processor 302 determines at step S704 that the protected sensitive data 602 is valid, the process 700 proceeds to step S706 where the processor 302 transforms the protected sensitive data 602 into unprotected sensitive data 405. The same symmetric key is used to encrypt the unprotected sensitive data 405 and decrypt the protected sensitive data 602.

In embodiments whereby the protected sensitive data 602 is encrypted sensitive data, at step S706 the processor 302 decrypts the protected sensitive data using a decryption key to obtain the unprotected sensitive data 405.

The processor 302 may obtain the decryption key by one of various methods.

The processor 302 may generate the decryption key using a unique device credential associated with the programmable device 110. Examples of the unique device credential have been described above. In embodiments whereby the programmable devices generate the decryption key using their unique device credential, it will be apparent that this will result in different decryption keys being generated for every programmable device.

Cloning of programmable devices can be prevented if the entire unique device credential used to generate the decryption key is not stored in volatile memory (e.g. flash) on the programmable device 110, though part of the unique device credential may be in volatile memory-the whole of the unique device credential cannot be in volatile memory if cloning of the volatile memory is to be prevented.

Alternatively, the processor 302 may receive the decryption key (or information to derive the decryption key) from a remote device (e.g. a remote server). In particular, the processor 302 may transmit registration information to the remote device via a communications network (e.g. the internet), and receive the decryption key (or information to derive the decryption key) from the remote device following successful registration with the remote server based on the registration information. Until it registers in this way, the protected sensitive data 602 is not accessible to the program 403. Hence the sensitive data will not even be decrypted/deobfuscated to volatile memory 314 unless the programmable device is properly registered on the system. In this case the security data processing device 102 may return information in production records (which may include secret information) to the third party device 104 that the remote server makes use of in future device registration, to ensure that clone devices are not let into operation.

In embodiments whereby the protected sensitive data 602 is obfuscated sensitive data, at step S706 the processor 302 deobfuscates the protected sensitive data 602 to obtain the unprotected sensitive data 405, the particular algorithm used is programmed into the program 403.

At step S708, the processor 302 stores the unprotected sensitive data 405 in volatile memory 314 at the third location (e.g. address3) whilst retaining the protected sensitive data 602 in non-volatile memory 324.

The unprotected sensitive data 405 can then be called/executed from volatile memory 314, called from other code in the clear that may be running in volatile memory 314 or non-volatile memory 324.

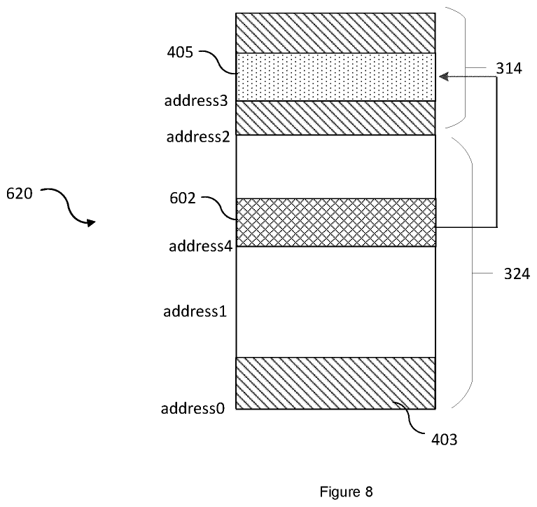

FIG. 8 illustrates the modified software image 620 (according to the second example of FIG. 6b) stored in non-volatile memory 324. FIG. 8 further illustrates how the programmable device 110 transforms the protected sensitive data 602 (stored at a second location, shown as address4, in non-volatile memory 324) into unprotected sensitive data 405 and storing the unprotected sensitive data 405 in volatile memory 314, whilst retaining the protected sensitive data 602 in non-volatile memory 324.

If the power to the programmable device 110 is removed the unprotected sensitive data 405 that has been stored in the volatile memory 314 will be lost so the unprotected sensitive data 405 is protected ‘at rest’. That is, if the programmable device 110 is powered off, the data stored in the volatile memory 314 will quickly decay leaving only the protected sensitive data 602 on the programmable device 110 in non-volatile memory 324

The program 403 may be a bootloader program. In these embodiments, the bootloader program 403 is executed by the processor 302 on power up of the programmable device 110.

In these embodiments, if the processor 302 determines at step S704 that the protected sensitive data 602 is not valid, the process 700 proceeds to step S710 whereby the processor 302 may prevent start-up of the programmable device 110, or allow start-up of the programmable device but prevent access to the protected sensitive data 602.

Embodiments of the present disclosure are not limited to the program 403 being a bootloader program which is executed by the processor 302 on power up of the programmable device 110. In particular, the program 403 can be executed upon the processor 302 receiving a request at any point during operation of the programmable device 110. This request may be received from another program (e.g. application code) running on the processor 302 of the programmable device 110.

Generally the code running on a programmable device 110 will be partitioned into a bootloader (e.g. program 403) that runs first, and application code that is run after secure boot is validated. The application program may call into the bootloader to access the protected sensitive data 602 either initially or at some time later when it needs the use of the protected sensitive data 602.

In the case where the decryption key information required is held remotely, the application program would first register with the remote server and would be given the decryption key (or information to derive the decryption key) as part of the registration. The application program can then use the decryption key to access the protected sensitive data 602 by providing the decryption key when sending a call to the bootloader.

If the processor 302 determines at step S704 that the protected sensitive data 602 is not valid, the process 700 proceeds to step S710 whereby the processor 302 may return an error notification. Alternatively, the processor 302 may insert failure returns or jumps to a single routine that returns common failure codes for all routines that would have been in the volatile memory 314 (to where the protected sensitive data 602 would have been stored if step S704 was successful).

It will be apparent that embodiments of the present disclosure advantageously keep sensitive data protected both during the process of provisioning the programmable device and at rest on the final product (e.g. a consumer device) that includes the programmable device. If individual credentials for a programmable device are used then it also prevents transferring the code into a cloned device as the cloned device will have different credentials and not be able to access the protected sensitive data correctly.

While the present disclosure has been particularly shown and described with reference to preferred embodiments, it will be understood to those skilled in the art that various changes in form and detail may be made without departing from the scope of the present disclosure as defined by the appendant claims.

1. A security data processing device comprising a processor, the processor configured to:
receive an encrypted data package from a third party device;
decrypt the encrypted data package to obtain:
a software image for programming onto a programmable device,
a first location identifying a location of unprotected sensitive data in the software image,
a second location of non-volatile memory of the programmable device for storage of protected sensitive data, and
a third location of volatile memory of the programmable device for storage of the unprotected sensitive data;
extract the unprotected sensitive data from the software image using the first location;
transform the unprotected sensitive data into protected sensitive data;
generate a modified software image by inserting the protected sensitive data into the software image and associating the protected sensitive data with the second location; and
transmit the modified software image to a programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

2. The security data processing device of claim 1, wherein the security data processing device is configured to transform the unprotected sensitive data into the protected sensitive data by obfuscating the unprotected sensitive data or by encrypting the unprotected sensitive data using an encryption key, optionally wherein the security data processing device is configured to generate the encryption key, optionally wherein the encryption key is unique to the programmable device.

3. (canceled)

4. (canceled)

5. The security data processing device of claim 2, wherein the security data processing device is further configured to:
transmit a request to the programming module for a unique device credential of the programmable device;
receive the device credential from the programming machine; and
generate the encryption key using the unique device credential.

6. The security data processing device of claim 5, wherein the unique device credential includes one or any combination of:
a serial number of the programmable device;
wafer information associated with a wafer used to manufacture the programmable device; and
information stored in a Secure Enclave on the programmable device;
information derived from information stored in the Secure Enclave on the programmable device.

7. The security data processing device of claim 2, wherein the security data processing device is further configured to:
transmit a request to the programming module for a key stored on the programmable device;
receive the key from the programming module; and
generate the encryption key using the key received from the programming module.

8. (canceled)

9. The security data processing device of claim 2, wherein the software image is for programming onto a plurality of programmable devices, and the encryption key is used for programming all or a subset of the plurality of programmable devices.

10. The security data processing device of claim 1, wherein the security data processing device is further configured to:
receive an authentication request from the third party device; and
transmit an authentication response to the third party device, wherein the encrypted data package is received from the third party device in response to being successfully authenticated by the third party device, optionally wherein the authentication response comprises one of more digital certificates associated with the security data processing device.

11. (canceled)

12. The security data processing device of claim 1, wherein:
the first location is the same as the second location;
the second location partially overlaps the first location; or
the second location is distinct from the first location

13. The security data processing device of claim 1, wherein the processor is configured to decrypt the encrypted data package using a decryption key which is unique to the security data processing device.

14. A non-transitory computer-readable medium, the non-transitory computer-readable medium storing instructions that, when executed by a processor, cause the processor to:
receive an encrypted data package from a third party device;
decrypt the encrypted data package to obtain:
a software image for programming onto a programmable device,
a first location identifying a location of unprotected sensitive data in the software image,
a second location of non-volatile memory of the programmable device for storage of protected sensitive data, and
a third location of volatile memory of the programmable device for storage of the unprotected sensitive data;
extract the unprotected sensitive data from the software image using the first location;
transform the unprotected sensitive data into protected sensitive data;
generate a modified software image by inserting the protected sensitive data into the software image and associating the protected sensitive data with the second location;
transmit the modified software image to the programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

15. A programmable device comprising:
a processor;
a non-volatile memory; and
a volatile memory; wherein the processor is configured to perform steps of:
retrieve protected sensitive data that is stored in non-volatile memory;
determine if the protected sensitive data is valid;
if the protected sensitive data is valid; the processor is configured to:
transform the protected sensitive data into unprotected sensitive data;
store the unprotected sensitive data in the volatile memory whilst retaining the protected sensitive data in non-volatile memory.

16. The programmable device of claim 15, wherein the programmable device is configured to transform the protected sensitive data into the unprotected sensitive data by deobfuscating the protected sensitive data.

17. The programmable device of claim 16, wherein the programmable device is configured to transform the protected sensitive data into the unprotected sensitive data by decrypting the protected sensitive data using a decryption key.

18. The programmable device of claim 17, wherein the processor is further configured to generate the decryption key using a unique device credential of the programmable device; or wherein the programmable device is further configured to transmit registration information to a remote device via a communications network, and receive the decryption key from the remote device following successful registration with the remote server based on the registration information.

19. (canceled)

20. The programmable device of claim 15, wherein the processor is configured to perform said steps in response to power being delivered to the programmable device, or wherein the processor is configured to perform said steps in response to receiving a request for the protected sensitive data;
optionally wherein if the protected sensitive data is invalid, the processor is configured to:
prevent start-up of the programmable device; or
allow start-up of the programmable device and prevent access to the protected sensitive data.

21. (canceled)

22. (canceled)

23. The programmable device of claim 15, wherein the processor is configured to determine if the protected sensitive data is valid based on one or more of:
determining that the protected sensitive data is complete;
determining that the protected sensitive data has been generated specifically for the programmable device;
successfully verifying the integrity of the protected sensitive data.

24. The programmable device of claim 15, wherein the non-volatile memory is flash memory and the volatile memory is Random Access Memory.

25. A non-transitory computer-readable medium, the non-transitory computer-readable medium storing instructions that, when executed by a processor of a programmable device, cause the processor to:
retrieve protected sensitive data that is stored in non-volatile memory of the programmable device;
determine if the protected sensitive data is valid;
if the protected sensitive data is valid; to:
transform the protected sensitive data into unprotected sensitive data; and
store the unprotected sensitive data in volatile memory of the programmable device whilst retaining the protected sensitive data in the non-volatile memory.

26. A method comprising:
receiving an encrypted data package from a third party device;
decrypting the encrypted data package to obtain:
a software image for programming onto a programmable device,
a first location identifying a location of unprotected sensitive data in the software image,
a second location of non-volatile memory of the programmable device for storage of protected sensitive data, and
a third location of volatile memory of the programmable device for storage of the unprotected sensitive data;
extracting the unprotected sensitive data from the software image using the first location;
transforming the unprotected sensitive data into protected sensitive data;
generating a modified software image by inserting the protected sensitive data into the software image and associating the protected sensitive data with the second location; and
transmitting the modified software image to a programming module for programming onto the programmable device, the modified software image comprising a program configured, when executed, to transform the protected sensitive data into unprotected sensitive data; and store the unprotected sensitive data at the third location in volatile memory of the programmable device whilst retaining the protected sensitive data at the second location in non-volatile memory of the programmable device.

27. A method comprising:
retrieving protected sensitive data that is stored in non-volatile memory;
determining if the protected sensitive data is valid; and
if the protected sensitive data is valid:
transforming the protected sensitive data into unprotected sensitive data; and
storing the unprotected sensitive data in the volatile memory whilst retaining the protected sensitive data in non-volatile memory.
